(19) United States
(12) Patent Application Publication
(10) Pub. No.: US 2015/0264094 A1
(43) Pub. Date: Sep. 17, 2015

(54) Interaction Method and Application Platform for Social Network Site

(71) Applicant: TENCENT TECHNOLOGY (SHENZHEN) COMPANY LIMITED, Shenzhen (CN)

(72) Inventors: Tieming Huang, Shenzhen (CN); Linjia Wan, Shenzhen (CN); Xi Chen, Shenzhen (CN)

(21) Appl. No.: 14/700,235

(22) Filed: Apr. 30, 2015

Related U.S. Application Data
(63) Continuation of application No. PCT/CN2013/084018, filed on Sep. 23, 2013.

(30) Foreign Application Priority Data
Nov. 7, 2012 (CN) 201210441152.6

(51) Int. Cl. H04L 29/06; H04L 29/08; H04L 12/58

(52) U.S. Cl. CPC H04L 65/403; H04L 51/32; H04L 67/02

(57) ABSTRACT

An interaction method and application platform for a social network site (SNS) are disclosed. The method includes: receiving a connection instruction of a user, and connecting to the user according to the connection instruction; receiving user information uploaded by the user or acquiring user information locally, and updating the user information to a preset information sharing space; and sharing information and performing anonymous SNS interaction between the current user and at least one other user based on the information sharing space. The present disclosure not only enhances an interaction manner between users, and expands a channel for the users to learn about each other, but also improves a success rate of user matching, and develops user relation chains, thereby generating abundant album resources and users with high quality content from whom high-quality users are extracted to form principally recommended users.

This application claims priority to Chinese Patent Application No. 2012104411526, filed with Chinese Patent Office on Nov. 7, 2012 and entitled “INTERACTION METHOD AND APPLICATION PLATFORM FOR SOCIAL NETWORK SITE”, which is incorporated herein by reference in its entirety.

### FIELD OF THE TECHNOLOGY

The present disclosure relates to the field of social network sites (SNSs), and in particular, to an interaction method and application platform for an SNS.

### BACKGROUND OF THE DISCLOSURE

QQ mailbox drift bottle is a manner of using various bottles as media via which the users communicate and develop user relation chains by means of actions such as throwing a bottle actively, picking a bottle actively, and replying actively. The bottles are the only channel for maintaining user relations, and a user selects, by picking a bottle and according to content included in the bottle, someone in whom the user has an interest for interaction.

However, existing drift bottle users can only develop relation chains between each other by means of one-to-one small circle interaction, so that the interaction manner and the channel for learning about each other are single, and user personal profiles, albums, status information, and the like cannot be shared, causing a low success rate of matching between users.

### SUMMARY

Various examples of the present disclosure provide an interaction method and application platform for an SNS, so as to enrich interaction manners between users using an instant messaging tool such as a drift bottle, and develop user relation chains.

One aspect of the present disclosure provides an interaction method for an SNS, including:

receiving a connection instruction of a user client, and connecting to the user client according to the connection instruction;

receiving user information uploaded by the user client or acquiring user information locally, and updating the user information to a preset information sharing space; and

sharing information and performing anonymous SNS interaction between the current user client and at least one other user client based on the information sharing space.

Another aspect of the present disclosure provides an interaction application platform for an SNS, including: at least one processor and a memory, the memory comprising a series of computer-readable instructions capable of making the at least one processor to:

receive a connection instruction of a user, and connect to the user client according to the connection instruction;

receive user information uploaded by the user client or acquire user information locally, and update the user information to a preset information sharing space; and

share information and perform anonymous SNS interaction between the current user client and at least one other user client based on the information sharing space.

The present disclosure provides an interaction method and application platform for an SNS, where a user is provided with an information sharing space for sharing content with a friend by using an instant messaging tool such as a drift bottle, where information such as an album picture, a real-time status, synchronized bottle content, and a personal profile of the user is stored in the information sharing space of the application platform, and information is shared and anonymous SNS interaction is performed between users based on the information sharing space, so that an interaction manner between users is enhanced, a channel for the users to learn about each other is expanded, a success rate of user matching is improved, and user relation chains are developed, thereby generating abundant album resources and users with high quality content from whom high-quality users are extracted to form principally recommended users.

### BRIEF DESCRIPTION OF THE DRAWINGS

FIG. 1 is a schematic flowchart of an interaction method for an SNS according to an embodiment of the present invention;

FIG. 2 is a schematic flowchart of receiving user information uploaded by a user and updating the user information to a preset information sharing space in an interaction method for an SNS according to an embodiment of the present invention;

FIG. 3 is a schematic flowchart of receiving user information uploaded by a user and updating the user information to a preset information sharing space in an interaction method for an SNS according to an embodiment of the present invention;

FIG. 4 is a schematic flowchart of acquiring user information locally and updating the user information to a preset information sharing space in an interaction method for an SNS according to an embodiment of the present invention;

FIG. 5 is an schematic instance diagram of a front end interface of a secret garden in an interaction method for an SNS according to an embodiment of the present invention;

FIG. 6 is a schematic flowchart of sharing information between a current user and at least one other user based on an information sharing space in an interaction method for an SNS according to an embodiment of the present invention;

FIG. 7 is a schematic flowchart of performing anonymous SNS interaction between a current user and at least one other user based on an information sharing space in an interaction method for an SNS according to an embodiment of the present invention;

FIG. 8 is a schematic diagram of an interface of a sight in an interaction method for an SNS according to an embodiment of the present invention;

FIG. 9 is a schematic structural diagram of an interaction application platform for an SNS according to an embodiment of the present invention;

FIG. 10 is a schematic structural diagram of a data acquisition module of an interaction application platform for an SNS according to an embodiment of the present invention;

FIG. 11 is a schematic structural diagram of a sharing and interaction module of an interaction application platform for an SNS according to an embodiment of the present invention;

FIG. 12 is another schematic structural diagram of a sharing and interaction module of an interaction application platform for an SNS according to an embodiment of the present invention; and

FIG. 13 is a schematic structural diagram of a list acquisition unit of an interaction application platform for an SNS according to an embodiment of the present invention.

To make the technical solutions of the present disclosure clearer, further description is given below in detail with reference to the accompanying drawings.

### DESCRIPTION OF EMBODIMENTS

The solutions of the embodiments of the present invention are mainly: storing information such as an album picture, a real-time status, synchronized bottle content, and a personal profile of a user in an information sharing space of an application platform by means of uploading by the user, and sharing information and performing anonymous SNS interaction between users based on the information sharing space, so as to enhance an interaction manner between users, expand a channel for the users to learn about each other, develop user relation chains, and facilitate extracting high-quality users from the users.

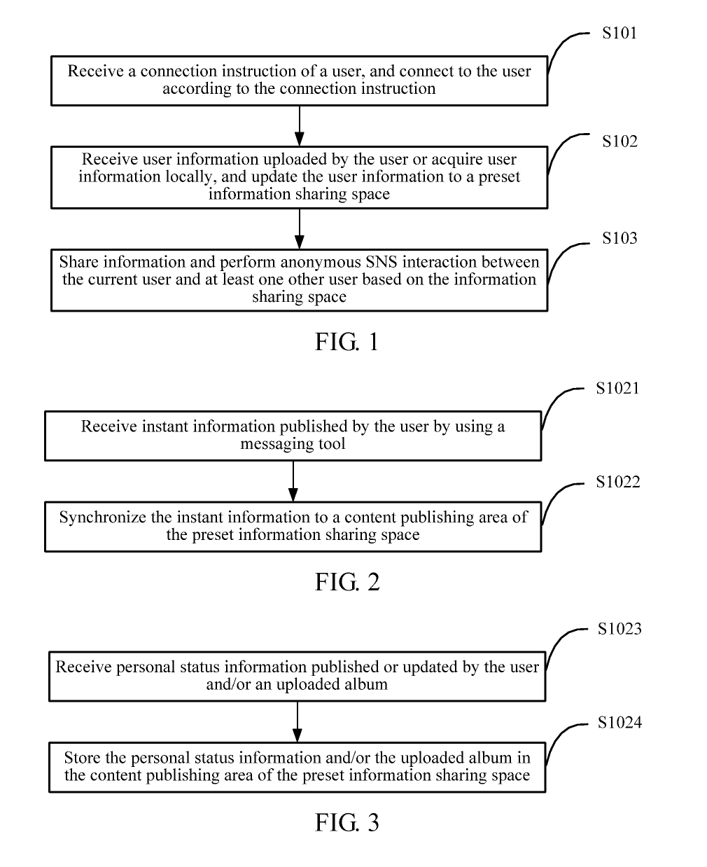

As shown in FIG. 1, an embodiment of the present invention provides an interaction method for an SNS, including:

Step S101: An application platform receives a connection instruction of a user client, and connects to the user client according to the connection instruction.

The application platform may be a computing device that include one or more processors and a memory storing programs executed by the one or more processors. In the embodiment, the application platform can be borne in a mailbox platform, and the application platform connects to the user client according to the connection instruction of the user.

In one embodiment, the user client may be a mobile terminal, a personal computer, a desktop computer, or any other computing device that a user can communicate with other users.

A secret garden in a QQ mailbox drift bottle is used as an example. A user enters a secret garden of the user by clicking on an avatar of the user.

Step S102: Receive user information uploaded by the user client or acquire user information locally, and update the user information to a preset information sharing space.

An information sharing space for a user client to share information is preset in a background of the application platform, where the information sharing space includes a personal profile area, a content publishing area, a friend list and friend recommendation area (for the drift bottle, that is, a bottle friend list and bottle friend recommendation area).

The personal profile area includes content such as an avatar, a nick name, an identity, a location, an individual signature, and a points level of the user; and the content publishing area includes information such as an album and a personal status.

The user client may upload published or updated personal status information and an album to the application platform, or may publish instant information by using an instant messaging tool such as a drift bottle, and the application platform updates the foregoing information and user information such as a locally acquired user personal profile to the information sharing space.

Step S103: Share information and perform anonymous SNS interaction between the current user client and at least one other user client based on the information sharing space.

When there is user information updated in the information sharing space, the application platform sends an update notification message to a friend of the current user client. The current user client can share information and perform anonymous SNS interaction with another user client based on the information sharing space.

Specifically, as shown in FIG. 2, as an instance, steps of the receiving user information uploaded by the user client and updating the user information to a preset information sharing space in the above step S102 include:

Step S1021: Receive instant information published by the user client by using a messaging tool.

Step S1022: Synchronize the instant information to a content publishing area of the preset information sharing space.

For example, a messaging tool is a drift bottle. In a virtual scene, a user of the user client sets a type of a synchronized bottle, and after the setting, once the user throws a bottle of this type, the secret garden synchronizes content of this bottle to a personal status in the secret garden. Once there is updated content in the secret garden of the user, a bottle friend of the user can receive an update notification. The update notification is displayed next to a personal avatar of the user on a beach home page in the form of a number.

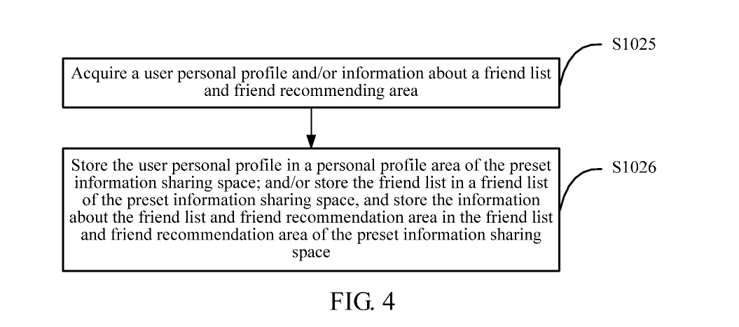

As shown in FIG. 3, as another instance, steps of the receiving user information uploaded by the user and updating the user information to a preset information sharing space in the above step S102 include:

Step S1023: Receive personal status information published or updated by the user client, and/or an uploaded album.

Step S1024: Store the personal status information and/or the uploaded album in a content publishing area of the preset information sharing space.

For example, for the drift bottle, the user may publish a mood status in the secret garden of the drift bottle and upload a personal photo. Once there is updated content (a newly published status) in the secret garden of the user, a bottle friend of the user can receive an update notification, and the update notification is displayed next to the avatar of the user on the beach home page in the form of a number.

As shown in FIG. 4, as still another instance, steps of the acquiring user information locally and updating the user information to a preset information sharing space in the above step S102 include:

Step S1025: Acquire a user personal profile and/or information about a friend list and friend recommendation area.

Step S1026: Store the user personal profile in a personal profile area of the preset information sharing space; and/or store the friend list in a friend list of the preset information sharing space, and store the information about the friend list and friend recommendation area in the friend list and friend recommendation area of the preset information sharing space.

During a specific implementation, information such as a personal profile, a synchronized bottle, a bottle friend, and a recommended bottle friend of the foregoing user is existing data, and after being copied by the secret garden in the background, the data is displayed at a front end of the secret garden.

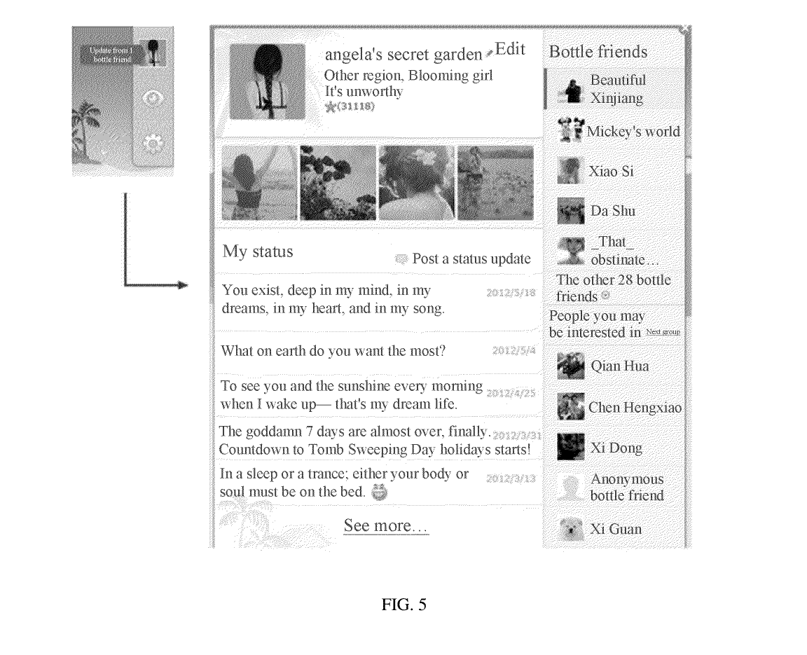

A schematic instance diagram of a front end interface of the secret garden in this embodiment is shown in FIG. 5.

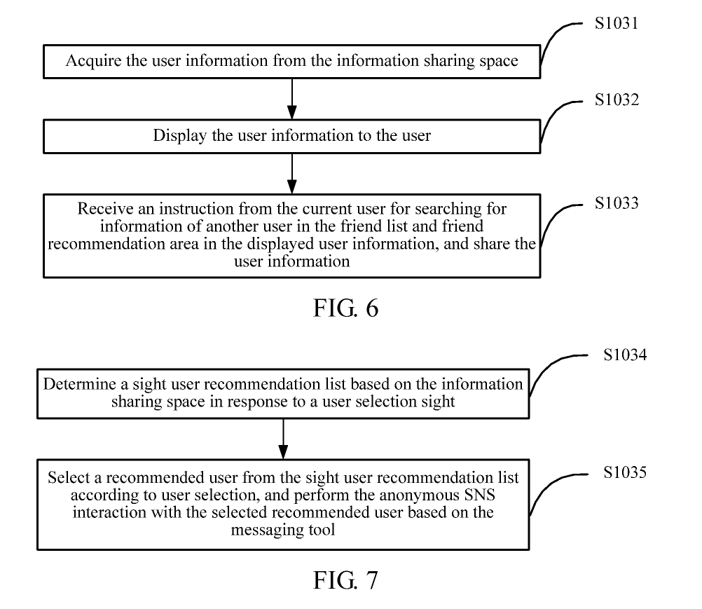

As shown in FIG. 6, steps of the sharing information between the current user client and at least one other user client based on the information sharing space in the above step S103 include:

Step S1031: Acquire the user information from the information sharing space.

Step S1032: Display the user information to the user client.

For example, for the drift bottle, after being copied by the secret garden in the background, information such as the personal profile, the synchronized bottle, the bottle friend, and the recommended bottle friend of the user in the information sharing space is displayed at a front end of the secret garden.

Step S1033: Receive an instruction from the current user client for searching for information of another user client in the friend list and friend recommendation area in the displayed user information, and share the user information.

In the front end interface of the secret garden shown in FIG. 5, the user may search the bottle friend list or a recommended bottle friend list for user information in which the user has an interest, or may search for user information having updated content according to a notification message next to the personal avatar of the user on the beach home page.

As shown in FIG. 7, steps of the performing anonymous SNS interaction between the current user client and at least one other user client based on the information sharing space in the above step S103 include:

Step S1034: Determine a sight user recommendation list based on the information sharing space in response to a user selection sight.

When a sight function is selected, the application platform pulls a list of other users from the friend list and friend recommendation area of the information sharing space according to an attribute of the current user; filters the list of other users according to a predetermined filtering policy; and creates a pull index for each of the users in the list of other users after the filtering according to an attribute of the user, and uses the pull index and the list of other users after the filtering as the sight user recommendation list.

Step S1035: Select a recommended user from the sight user recommendation list according to user selection, and perform the anonymous SNS interaction with the selected recommended user based on the messaging tool.

Specifically, the secret garden of the drift bottle is used as an example. A sight is a function derived from the secret garden, and is essentially a manner of greeting. More specifically, the drift bottle is similar to a random manner of making friends, that is, the user does not know who will pick a thrown bottle before the bottle is replied to, which is limited by a rule of the drift bottle. The sight function enables the user to throw a bottle to a designated bottle friend. During using a picking function of the drift bottle, a user has a chance to pick the sight, or a user of a higher level may select the sight function directly. After choosing to use the sight function, the user can see a list of recommended users by unfolding the sight, and can greet a user in the list of the recommended users by clicking on the user in the list of the recommended users, that is, the user throws a bottle to the other user in a one-to-one manner accurately.

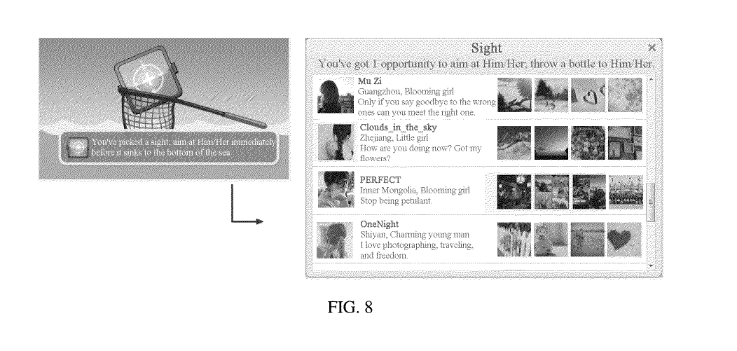

During a specific implementation, the front end of the secret garden displays a batch of users on a page by pulling out the batch of the users from the background based on the attribute of the user, and reports logged in users to a back end of the sight simultaneously. The back end of the sight accepts the users reported by the front end, and filters out low-quality users according to policies such as an activity degree, with or without a picture, and a click through rate, so as to add the users after the filtering to a user pool by using a filter. The user pool creates, based on different attributes (such as gender, a living city, interests, and an activity rate), an index for each of the users after the filtering, so that when the front end of the secret garden acquires an object, a suitable person (who tends to have a conversation with the user) is easily matched with the user. An interface of the sight in this instance is shown in FIG. 8.

It can be seen from the foregoing solution that a secret garden is newly added in the drift bottle function in this embodiment, which provides a space for a user to share content with a drift bottle friend. Information such as an album picture, a real-time status, synchronized bottle content, and a personal profile of the user forms a theme of the secret garden, so that user anonymous sharing is achieved, interaction manners between drift bottle users are enriched, and the secret garden forms an anonymous microblog type SNS application. Personal profiles are displayed by using the secret garden, which expands a channel for the users to learn about each other, facilitates development of user relation chains, and improves a success rate of user matching, thereby generating, based on the secret garden, abundant album resources and users with high quality content from whom high-quality users are extracted to form principally recommended users of a sight.

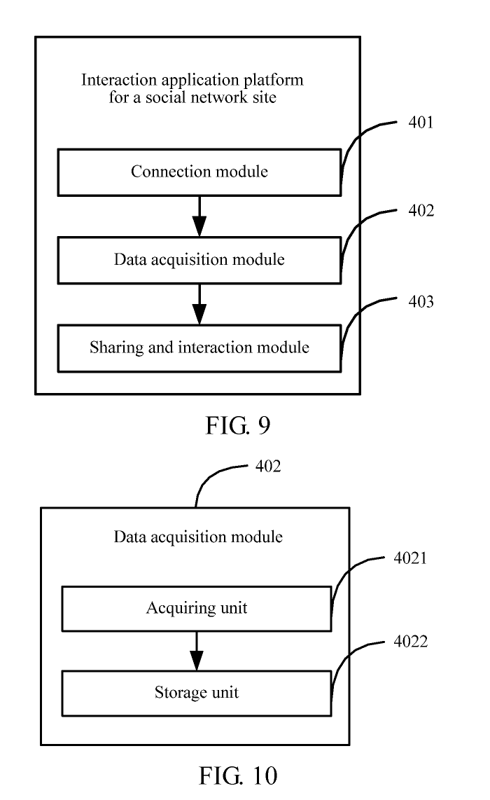

As shown in FIG. 9, an embodiment of the present invention provides an interaction application platform for an SNS, including: a connection module 401, a data acquisition module 402, and a sharing and interaction module 403, where

the connection module 401 is configured to receive a connection instruction of a user client, and connect to the user client according to the connection instruction;

the data acquisition module 402 is configured to receive user information uploaded by the user client or acquire user information locally, and update the user information to a preset information sharing space; and

the sharing and interaction module 403 is configured to share information and perform anonymous SNS interaction between the current user client and at least one other user client based on the information sharing space.

The interaction application platform for an SNS can be implemented by a software application program, hardware having an application program fixedly installed, or a combination thereof. The interaction application platform for an SNS is borne in a mailbox platform, and the connection module 401 of the application platform connects to the user client according to the connection instruction of the user client.

A secret garden in a QQ mailbox drift bottle is used as an example. A user enters a secret garden of the user by clicking on an avatar of the user.

An information sharing space for a user client to share information is preset in a background of the application platform, where the information sharing space includes a personal profile area, a content publishing area, a friend list and friend recommendation area (for the drift bottle, that is, a bottle friend list and bottle friend recommendation area).

The personal profile area includes content such as an avatar, a nick name, an identity, a location, an individual signature, and a points level of the user; and the content publishing area includes information such as an album and a personal status.

The user client may upload published or updated personal status information and an album to the application platform, or may publish instant information by using an instant messaging tool such as a drift bottle; and the data acquisition module 402 of the application platform updates the foregoing information and user information such as a locally acquired user personal profile to the information sharing space.

When there is user information updated in the information sharing space, the application platform sends an update notification message to a friend of the current user. The current user can share information and perform anonymous SNS interaction with another user based on the information sharing space by using the sharing and interaction module 403.

Specifically, as shown in FIG. 10, as an instance, the data acquisition module 402 includes: an acquiring unit 4021 and a storage unit 4022, where

the acquiring unit 4021 is configured to receive instant information published by the user client by using a messaging tool; and

the storage unit 4022 is configured to synchronize the instant information to a content publishing area of the preset information sharing space.

For example, a messaging tool is a drift bottle. The user sets a type of a synchronized bottle, and after the setting, once the user throws a bottle of this type, the secret garden synchronizes content of this bottle to a personal status in the secret garden. Once there is updated content in the secret garden of the user, a bottle friend of the user can receive an update notification. The update notification is displayed next to a personal avatar of the user on a beach home page in the form of a number.

Further, as another instance, the acquiring unit 4021 is further configured to receive personal status information published or updated by the user client and/or an uploaded album; and

the storage unit 4022 is further configured to store the personal status information and/or the uploaded album in the content publishing area of the preset information sharing space.

For example, for the drift bottle, the user may publish a mood status in the secret garden of the drift bottle and upload a personal photo. Once there is updated content (a newly published status) in the secret garden of the user, a bottle friend of the user can receive an update notification, and the update notification is displayed next to the avatar of the user on the beach home page in the form of a number.

Further, as still another instance, the acquiring unit 4021 is further configured to acquire a user personal profile and/or information about a friend list and friend recommendation area; and the storage unit 4022 is further configured to store the user personal profile in a personal profile area of the preset information sharing space; and/or store the friend list in a friend list of the preset information sharing space, and store the information about the friend list and friend recommendation area in the friend list and friend recommendation area of the preset information sharing space.

During a specific implementation, information such as a personal profile, a synchronized bottle, a bottle friend, and a recommended bottle friend of the foregoing user is existing data, and after being copied by the secret garden in the background, the data is displayed at a front end of the secret garden.

A schematic instance diagram of a front end interface of the secret garden in this embodiment is shown in FIG. 5.

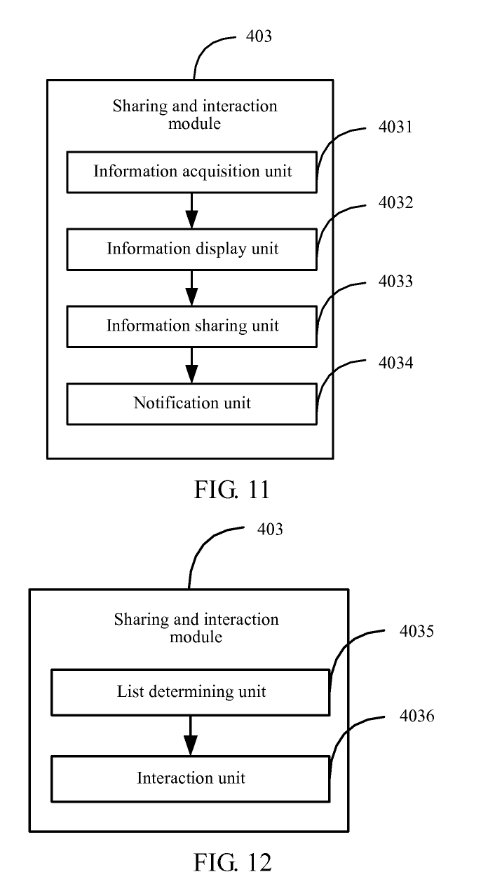

As shown in FIG. 11, as an instance, the sharing and interaction module 403 includes: an information acquisition unit 4031, an information display unit 4032, and an information sharing unit 4033, where

the information acquisition unit 4031 is configured to acquire the user information from the information sharing space;

the information display unit 4032 is configured to display the user information to the user client; and

the information sharing unit 4033 is configured to receive an instruction from the current user for searching for information of another user in the friend list and friend recommendation area in the displayed user information, and share the user information.

Further, the sharing and interaction module 403 includes:

a notification unit 4034, configured to send an update notification message to a friend of the current user. When there is user information updated in the information sharing space, the notification unit 4034 of the application platform sends an update notification message to a friend of the current user.

For example, for the drift bottle, after being copied by the secret garden in the background, information such as the personal profile, the synchronized bottle, the bottle friend, and the recommended bottle friend of the user in the information sharing space is displayed at a front end of the secret garden.

In the front end interface of the secret garden shown in FIG. 5, the user may search the bottle friend list or a recommended bottle friend list for user information in which the user has an interest, or may search for user information having updated content according to a notification message next to the personal avatar of the user on the beach home page.

As shown in FIG. 12, as another instance, the sharing and interaction module 403 includes: a list determining unit 4035 and an interaction unit 4036, where

the list determining unit 4035 is configured to determine a sight user recommendation list based on the information sharing space in response to a user selection sight; and

the interaction unit 4036 is configured to select a recommended user from the sight user recommendation list according to user selection, and perform the anonymous SNS interaction with the selected recommended user based on the messaging tool.

Specifically, the secret garden of the drift bottle is used as an example. A sight is a function derived from the secret garden, and is essentially a manner in which the user greets a designated bottle friend. During using a picking function of the drift bottle, a user has a chance to pick the sight, or a user of a higher level may select the sight function directly. After choosing to use the sight function, the user can see a list of recommended users by unfolding the sight, and can greet a user in the list of the recommended users by clicking on the user in the list of the recommended users, that is, the user throws a bottle to the other user in a one-to-one manner accurately.

During a specific implementation, the front end of the secret garden displays a batch of users on a page by pulling out the batch of the users from the background based on an attribute of the user, and reports logged in users to a back end of the sight simultaneously. The back end of the sight accepts the users reported by the front end, and filters out low-quality users according to policies such as an activity degree, with or without a picture, and a click through rate, so as to add the users after the filtering to a user pool by using a filter. The user pool creates, based on different attributes (such as gender, a living city, interests and an activity rate), an index for each of the users after the filtering, so that when the front end of the secret garden acquires an object, a suitable person (who tends to have a conversation with the user) is easily matched with the user. An interface of the sight in this instance is shown in FIG. 8.

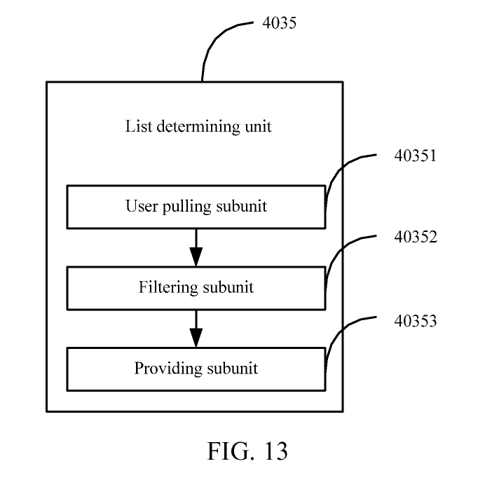

As shown in FIG. 13, the list determining unit 4035 includes: a user pulling subunit 40351, a filtering subunit 40352, and a providing subunit 40353, where

the user pulling subunit 40351 is configured to pull a list of other users from the friend list and friend recommendation area of the information sharing space according to an attribute of the current user;

the filtering subunit 40352 is configured to filter the list of other users according to a predetermined filtering policy; and

a providing subunit 40353 is configured to create, according to an attribute of the user, a pull index for each of the users in the list of other users after the filtering and use the pull index and the list of other users after the filtering as the sight user recommendation list.

The interaction method and application platform for an SNS of the embodiments of the present invention provide an information sharing space for a user to share content with a friend by using an instant messaging tool such as a drift bottle, where information such as an album picture, a real-time status, synchronized bottle content, and a personal profile of the user is stored in the information sharing space of the application platform, and information is shared and anonymous SNS interaction is performed between users based on the information sharing space, so that an interaction manner between users is enhanced, a channel for the users to learn about each other is expanded, a success rate of user matching is improved, and user relation chains are developed, thereby generating abundant album resources and users with high quality content from whom high-quality users are extracted to form principally recommended users.

The embodiments of the present invention can construct the interaction platform of the embodiments of the present invention and implement the interaction method for an SNS of the embodiments of the present invention by running, on a device such as a universal computing device of a computer that includes processing components and storage components such as a central processing unit (CPU), a random access memory (RAM), and a read-only memory (ROM), a computer program (including program code) that can perform the interaction method for an SNS according to the embodiments of the present invention. The computer program can be recorded on, for example, a computer readable record medium, and can be loaded on the foregoing computing device by using the computer readable record medium and run on the foregoing computing device.

The foregoing descriptions are merely embodiments of the present invention but are not intended to limit the patent scope of the present disclosure. Any equivalent modifications made to the structures or processes based on the content of the specification and the accompanying drawings of the present disclosure for direct or indirect use in other relevant technical fields shall also be encompassed in the patent protection scope of the present disclosure.

What is claimed is:

1. An interaction method for a social network site (SNS), comprising:
at a computing device having one or more processors and memory storing programs executed by the one or more processors:
receiving a connection instruction of a user client, and connecting to the user client according to the connection instruction;
receiving user information uploaded by the user client or acquiring user information locally, and updating the user information to a preset information sharing space; and
sharing information and performing anonymous SNS interaction between the current user client and at least one other user client based on the information sharing space.

2. The method according to claim 1, wherein the receiving user information uploaded by the user client or acquiring user information locally, and updating the user information to a preset information sharing space comprises:
receiving instant information that is published by the user client by using a messaging tool; and
synchronizing the instant information to a content publishing area of the preset information sharing space.

3. The method according to claim 1, wherein the receiving user information uploaded by the user client or acquiring user information locally, and updating the user information to a preset information sharing space comprises:
receiving personal status information published or updated by the user client, and/or an uploaded album; and
storing the personal status information and/or the uploaded album in a content publishing area of the preset information sharing space.

4. The method according to claim 1, wherein the receiving user information uploaded by the user client or acquiring user information locally, and updating the user information to a preset information sharing space comprises:
acquiring a user personal profile and/or information about a friend list and friend recommendation area; and
storing the user personal profile in a personal profile area of the preset information sharing space; and/or storing the information about the friend list and friend recommendation area in the friend list and friend recommendation area of the preset information sharing space.

5. The method according to claim 1, wherein the sharing information between the current user client and at least one other user client based on the information sharing space comprises:
acquiring the user information from the information sharing space;
displaying the user information to the user; and
receiving an instruction from the current user client for searching for information of another user in the friend list and friend recommendation area in the displayed user information, and sharing the user information.

6. The method according to claim 5, wherein the sharing information between the current user client and at least one other user client based on the information sharing space further comprises:
sending an update notification message to a friend of the current user.

7. The method according to claim 1, wherein the performing anonymous SNS interaction between the current user client and at least one other user client based on the information sharing space comprises:
determining a sight user recommendation list based on the information sharing space in response to a user selection sight; and
selecting a recommended user from the sight user recommendation list according to user selection, and performing the anonymous SNS interaction with the selected recommended user based on the messaging tool.

8. The method according to claim 7, wherein the determining a sight user recommendation list based on the information sharing space in response to a user selection sight comprises:
pulling a list of other users from the friend list and friend recommendation area of the information sharing space according to an attribute of the current user;
filtering the list of other users according to a predetermined filtering policy; and
creating, according to an attribute of the user, a pull index for each of the users in the list of other users after the filtering, and using the pull index and the list of other users after the filtering as the sight user recommendation list.

9. An interaction application platform for a social network site (SNS), comprising: at least one processor and a memory, the memory comprising a series of computer-readable instructions capable of making the at least one processor to:
receive a connection instruction of a user, and connect to the user client according to the connection instruction;
receive user information uploaded by the user client or acquire user information locally, and update the user information to a preset information sharing space; and
share information and perform anonymous SNS interaction between the current user client and at least one other user client based on the information sharing space.

10. The application platform according to claim 9, wherein the computer-readable instructions are capable of making the at least one processor to:
receive instant information that is published by the user client by using a messaging tool; and
synchronize the instant information to a content publishing area of the preset information sharing space.

11. The application platform according to claim 10, wherein the computer-readable instructions are capable of making the at least one processor to:
receive personal status information published or updated by the user client and/or an uploaded album; and
store the personal status information and/or the uploaded album in the content publishing area of the preset information sharing space.

12. The application platform according to claim 10, wherein the computer-readable instructions are capable of making the at least one processor to:
acquire a user personal profile and/or information about a friend list and friend recommendation area; and
store the user personal profile of the user in a personal profile area of the preset information sharing space; and/or store the information about the friend list and friend recommendation area in the friend list and friend recommendation area of the preset information sharing space.

13. The application platform according to claim 9, wherein the computer-readable instructions are capable of making the at least one processor to:
acquire the user information from the information sharing space;
display the user information to the user; and
receive an instruction from the current user client for searching for information of another user in the friend list and friend recommendation area in the displayed user information, and share the user information.

14. The application platform according to claim 13, wherein the computer-readable instructions are capable of making the at least one processor to:
send an update notification message to a friend of the current user.

15. The application platform according to claim 9, wherein the computer-readable instructions are capable of making the at least one processor to:
determine a sight user recommendation list based on the information sharing space in response to a user selection sight; and
select a recommended user from the sight user recommendation list according to user selection, and perform the anonymous SNS interaction with the selected recommended user based on the messaging tool.

16. The application platform according to claim 15, wherein the computer-readable instructions are capable of making the at least one processor to:
pull a list of other users from the friend list and friend recommendation area of the information sharing space according to an attribute of the current user;
filter the list of other users according to a predetermined filtering policy; and
create, according to an attribute of the user, a pull index for each of the users in the list of other users after the filtering, and use the pull index and the list of other users after the filtering as the sight user recommendation list.
